(19) United States
(12) Patent Application Publication
(10) Pub. No.: US 2022/0253632 A1
(43) Pub. Date: Aug. 11, 2022

(54) AI PROCESS FLOW MANAGEMENT SYSTEM AND METHOD FOR AUTOMATIC VISUAL INSPECTION

(71) Applicant: LEADTEK RESEARCH INC., New Taipei City (TW)

(72) Inventor: WEI-YEN LIN, New Taipei City (TW)

(21) Appl. No.: 17/320,223

(22) Filed: May 14, 2021

(30) Foreign Application Priority Data
Feb. 9, 2021 (TW) 110105095

(51) Int. Cl. G06K 9/00; G06N 20/00; G06N 5/04; G06T 7/00; G06T 1/20

(52) U.S. Cl. CPC G06K 9/00671; G06N 20/00; G06T 1/20; G06T 7/0002; G06N 5/04

(57) ABSTRACT

An AI process flow management system and method for automatic visual inspection are introduced, allowing an edge computing apparatus to exchange data with an AI cloud apparatus through a network, and allowing the AI cloud apparatus to perform training and provide a report to the edge computing apparatus. During execution of the edge computing apparatus and AI cloud apparatus in a training stage, the AI cloud apparatus fetches image information, generates label information according to the image information, creates a training model according to the label information, updates the training model, and allows the updated training model to be downloaded by the edge computing apparatus. The training stage is restarted in real time through AI technology, and the training model is created and updated in real time through the label information, thereby enhancing visual inspection efficiency.

### CROSS-REFERENCE TO RELATED APPLICATION

This non-provisional application claims priority under 35 U.S.C. § 119(a) on Patent Application No(s). 110105095 filed in Taiwan, R.O.C. on Feb. 9, 2021, the entire contents of which are hereby incorporated by reference.

### BACKGROUND OF THE INVENTION

### 1. Field of the Invention

The present disclosure relates to automatic management systems and methods, and in particular to an AI process flow management system and method for automatic visual inspection.

### 2. Description of the Related Art

Owing to ever-changing technologies, electronic products with touch panels, operating panels, and display panels are widely used in human beings' daily life. Prior to their delivery by manufacturers, the panels not only undergo an inspection process flow but will also be mounted on the electronic products only if the panels are inspected and found flawless, with a view to ensuring high quality of the electronic products.

Conventional automatic optical inspection (AOI) is often applied to automatic visual examination technology for use in evaluation of the quality of the aforesaid finished panels. During the examination process, the panels are automatically scanned with an image capturing module to search for disastrous failures and qualitative defects (for example, scratches on a panel). The conventional automatic optical inspection (AOI) is a non-contact inspection method and thus is often applied to high-precision manufacturing processes and used in various stages thereof. Conventional AOI algorithms are based on image processing and morphological comparison and conventionally require setting plenty parameters and thresholds; the parameters vary with light and in consequence must be adjusted by engineers in order for the conventional AOI algorithms to be correctly computed. As a result, the conventional AOI algorithms add to the cost of system maintenance, require much manpower, and are inefficient.

In recent years, artificial intelligence (AI) is becoming more sophisticated and popular and is increasingly applied to the software systems in the field of automatic optical inspection (AOI). However, conventional AOI apparatuses and systems are mostly self-contained each and thus unlikely to comply with existing AI standard process flows.

Conventional automatic optical inspection (AOI) is often applied to high-precision manufacturing processes but must be adjusted manually and intensively and thus adds to the cost of system maintenance, requires much manpower, and is inefficient. Although artificial intelligence (AI) is in wide use, existing AOI apparatuses cannot be integrated into any emerging AI standard process flows and thus add to the cost of system maintenance, require much manpower, and are inefficient.

### BRIEF SUMMARY OF THE INVENTION

An objective of the present disclosure is to provide an AI process flow management system and method for automatic visual inspection, using artificial intelligence (AI), network communication, and automatic real-time updating and training, so as to provide an applicable, optimal model and thereby enhance visual inspection efficiency.

To achieve at least the above objective, the present disclosure provides an AI process flow management method for automatic visual inspection, with an AI cloud apparatus connected to a network and adapted to execute a training stage and thus execute the method, the method comprising the steps of:

fetching at least one image information;

generating at least one label information according to the image information;

creating a training model according to the label information; and

updating the training model and allowing the updated training model to be downloaded.

The method enables the AI cloud apparatus to fetch the image information through a network, label the fetched image information, generate the label information, automatically create the training model according to the label information, update the training model in real time, and allow users to download the updated training model. The training stage is restarted in real time through AI technology. The training model is generated in real time and updated according to the label information, thereby enhancing visual inspection efficiency.

AI process flow management system for automatic visual inspection, comprising:

an edge computing apparatus connected to a network; and

an AI cloud apparatus for exchanging data with the edge computing apparatus through the network,

wherein, in order for the AI cloud apparatus to be executed in a training stage, the AI cloud apparatus fetches at least one image information, generates at least one label information according to the image information, creates a training model according to the label information, updates the training model, and allows the edge computing apparatus to download the updated training model, thereby allowing the edge computing apparatus to start an execution stage.

### BRIEF DESCRIPTION OF THE DRAWINGS

FIG. 1A is a block diagram according to the first preferred embodiment of the present disclosure.

FIG. 1B is another block diagram according to the first preferred embodiment of the present disclosure.

FIG. 2 is yet another block diagram according to the first preferred embodiment of the present disclosure.

FIG. 3 is a block diagram according to the second preferred embodiment of the present disclosure.

FIG. 4 is a block diagram according to the third preferred embodiment of the present disclosure.

FIG. 5 is a schematic view of a process flow of a training stage of an AI process flow management method according to a preferred embodiment of the present disclosure.

FIG. 6 is a schematic view of a process flow of an execution stage of the AI process flow management method according to a preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

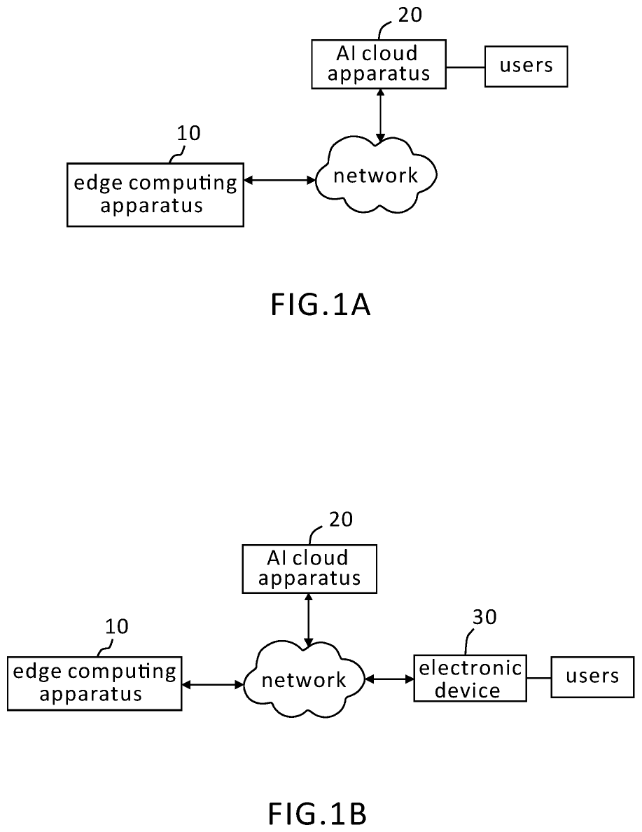

Referring to FIG. 1A, an AI process flow management system for automatic visual inspection is provided according to the first preferred embodiment of the present disclosure and comprises an edge computing apparatus 10 and an AI cloud apparatus 20. The edge computing apparatus 10 inspects product quality (for example, scratches on a panel) and stores an inspection result in the form of images. The edge computing apparatus 10 and the AI cloud apparatus 20 are each connected to a network and exchange data. The users manipulate the AI cloud apparatus 20 directly to effect training and provide a report, thereby offering the most suitable, feasible model to the edge computing apparatus 10.

In this preferred embodiment, in order for the users to manipulate the AI cloud apparatus 20 and for the AI cloud apparatus 20 to be executed in a training stage, the AI cloud apparatus 20 fetches at least one image information, generates at least one label information according to the image information, creates a training model according to the label information, updates the training model, and allows the updated training model to be downloaded to the edge computing apparatus 10. Then, the edge computing apparatus 10 creates an updated training model according to the training model to start an execution stage at any time. The edge computing apparatus 10 fetches a real-time image information, generates a recognition result according to the real-time image information and the updated training model, stores and returns the recognition result to the AI cloud apparatus 20. The training stage is restarted in real time through AI technology, and the training model is created and updated in real time through the label information, so as to enhance visual inspection efficiency.

Referring to FIG. 1B, in this preferred embodiment, to enhance ease of use, an electronic device 30 is connected to a network and adapted to log in the AI cloud apparatus 20. The network dispenses with limitations otherwise placed on distance and space, such that the users can operate the AI cloud apparatus 20 from a remote end, so as to enhance efficiency and ease of use. In this preferred embodiment, the electronic device 30 is a mobile device, a desktop computer or a laptop. In this preferred embodiment, the image information is in a plural number, and the label information is in a plural number, but the present disclosure is not limited thereto.

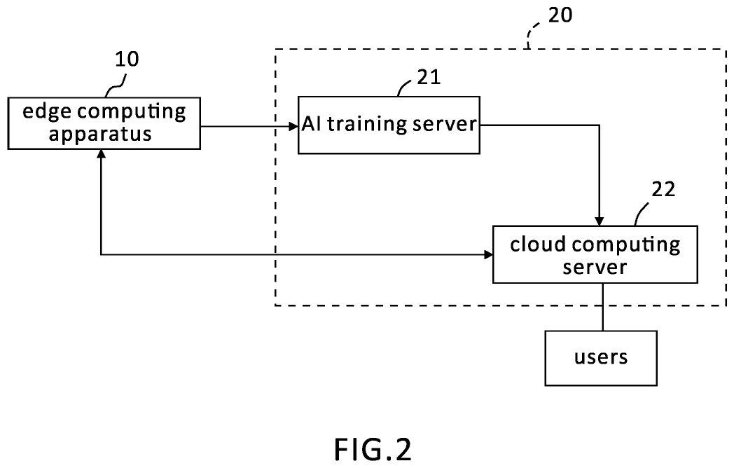

Referring to FIG. 2, in this preferred embodiment, the AI cloud apparatus 20 comprises an AI training server 21 and a cloud computing server 22. The cloud computing server 22 is connected to the edge computing apparatus 10 and the AI training server 21. The AI training server 21 is connected to the edge computing apparatus 10. The edge computing apparatus 10 stores an inspection result. When the users operate the cloud computing server 22 and execute the training stage, the cloud computing server 22 fetches the image information through the AI training server 21 and generates the label information according to the image information. Then, the cloud computing server 22 provides the label information to the AI training server 21 for training in order to create the training model. Next, the cloud computing server 22 updates the training model and allows the updated training model to be accessible to the edge computing apparatus 10 or downloadable.

In this preferred embodiment, some requirements are necessary for the cloud computing server 22 of the AI cloud apparatus 20 to generate the label information according to the image information. The requirements are described below. First, a label tool program is installed and executable on the cloud computing server 22. Second, the users execute the label tool program. Third, when the image information comprises at least one defective information, the users use the label tool program to label the image information which has defective information, so as to generate the label information. The purpose of using the label tool program to generate the label information is to optimize and enhance the accuracy and performance of a training model. In this preferred embodiment, the label information comprises an object inspection category information and/or a semantic segmentation category information.

In this preferred embodiment, the cloud computing server 22 of the AI cloud apparatus 20 further comes with and executes at least one scheduled training program and a performance management tool program. The users operate the scheduled training program. The scheduled training program is configured with training models (for example, CNN-Based Models, Faster R-CNN, Yolo, Unet, DeepLab, Mask R-CNN) or has built-in training models (for example, CNN-Based Models, Faster R-CNN, Yolo, Unet, DeepLab, Mask R-CNN) in order to perform scheduled training and use the performance management tool program to record at least one performance index for use in training and inference. In this preferred embodiment, the performance index comprises a time information and a resource consumption information. The resource consumption information comprises CPU/RAM resource consumption information and GPU Core/GPU RAM resource consumption information. In this preferred embodiment, the scheduled training program and the performance management tool program are executed on a visualized graphic interface and displayed on the visualized graphic interface, thereby facilitating their operation and use by the users.

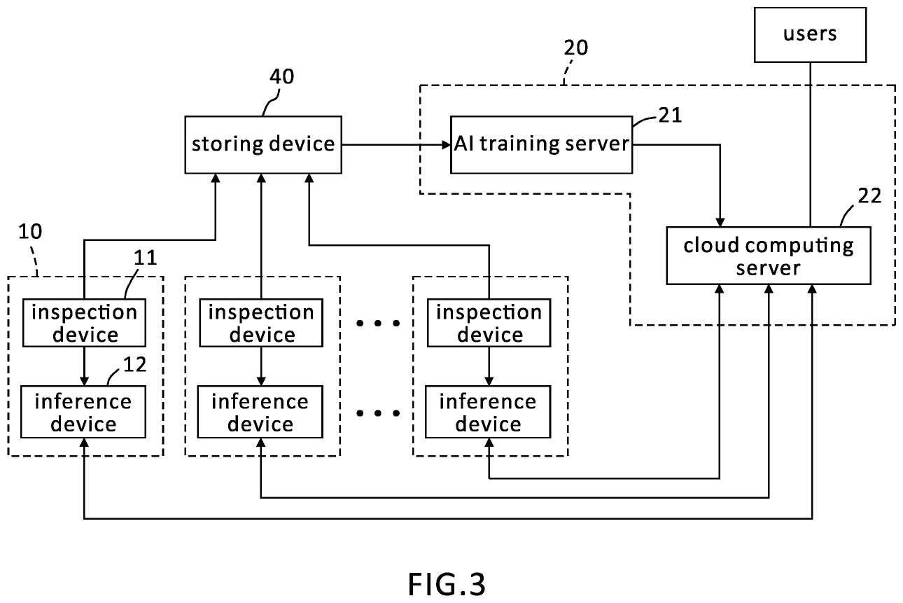

Referring to FIG. 3, unlike the first preferred embodiment, the second preferred embodiment provides the edge computing apparatuses 10 and a storing device 40. The edge computing apparatuses 10 are each connected to the cloud computing server 22 of the AI cloud apparatus 20 through a network whereby image informations fetched by the edge computing apparatuses 10 are sent to AI training server 21 of the AI cloud apparatus 20. In this preferred embodiment, the storing device 40 is at least one server and has a storing communication protocol. The storing device 40 is disposed between the cloud computing server 22 of the AI cloud apparatus 20 and the edge computing apparatuses 10 and adapted to collect and compile the image informations fetched by the edge computing apparatuses 10. In the presence of production lines at a production line end, the image informations fetched by the edge computing apparatuses 10 are collectively stored in one single storing apparatus to enhance management process flow efficiency.

Referring to FIG. 3, in this preferred embodiment, the edge computing apparatuses 10 each comprise an inspection device 11 and an inference device 12. The inference device 12 is connected to the inspection device 11. The inspection devices 11 of the edge computing apparatuses 10 each send the image informations to the AI training server 21 of the AI cloud apparatus 20 through the storing device 40. The inference devices 12 are connected to the cloud computing servers 22, respectively. In this preferred embodiment, the inference devices 12 download the training model from the cloud computing server 22, and the inspection devices 11 fetch the real-time image information. The inference devices 12 generate the recognition result according to the real-time image information and the training model and return the recognition result to the cloud computing server 22, so as to enhance computing performance and visual inspection efficiency. In this preferred embodiment, the recognition result comprises a defective recognition result.

In this preferred embodiment, the inspection device 11 is an automatic optical inspection (AOI) computer device. The inference device 12 is a graphics processing unit (GPU). The inference device 12 is disposed in the inspection device 11. The inference device 12 is a GPU inference computer device. The inference device 12 is proximally, wiredly connected to the inspection device 11 to reduce the cost of connecting to a network.

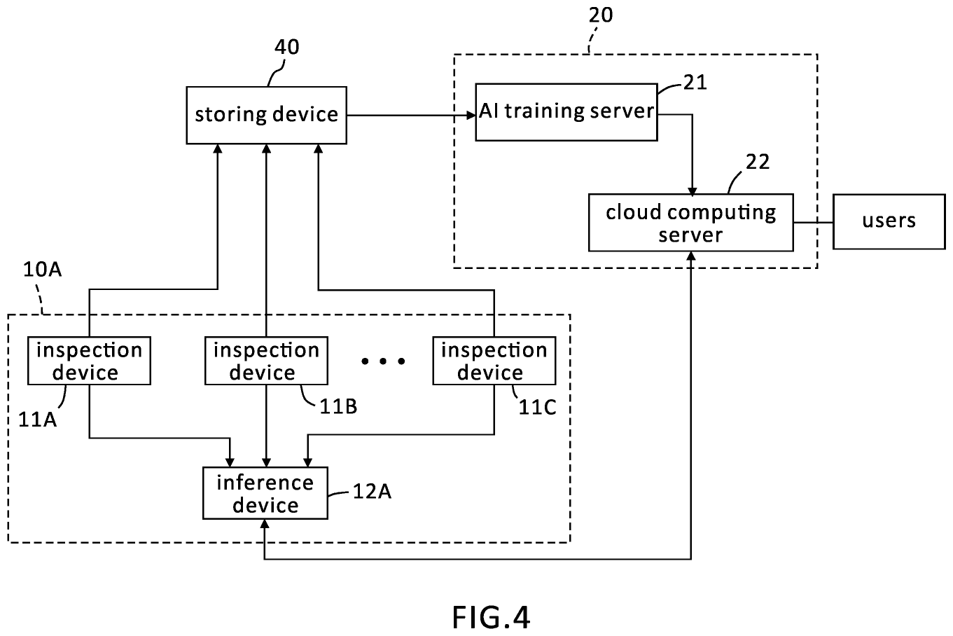

Referring to FIG. 4, unlike the first and second preferred embodiments, the third preferred embodiment provides the edge computing apparatus 10A. The edge computing apparatus 10A comprises inspection devices 11A,11B,11C and an inference device 12A. The inspection devices 11A, 11B, 11C are each connected to the inference device 12A. The inspection devices 11A, 11B, 11C send the image information to the training server 21 of the AI cloud apparatus 20 through the storing device 40. The inference device 12A downloads the training model from the cloud computing server 22 of the AI cloud apparatus 20. The inspection devices 11A,11B,11C fetch all the real-time image informations. The inference device 12 generates the recognition result according to the real-time image informations and the training model and returns the recognition result to the cloud computing server 22 of the AI cloud apparatus 20. The inspection devices 11A,11B,11C have a one-to-one relationship with the inference device 12A, so as to reduce the cost of constructing the inference device 12A.

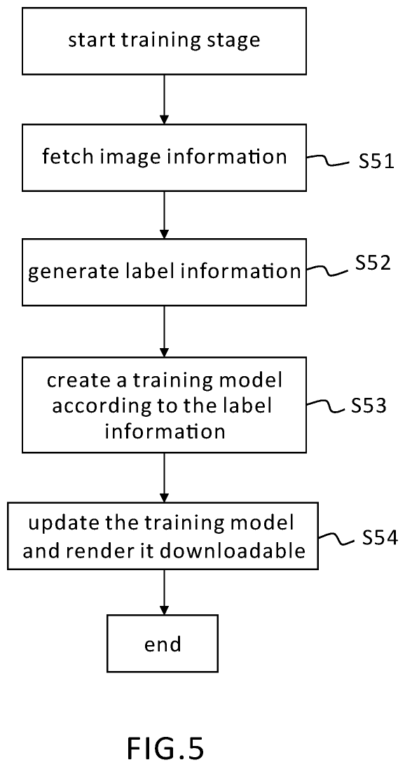

The present disclosure further provides an AI process flow management method for automatic visual inspection, characterized in that the AI cloud apparatus 20 is connected to a network and adapted to execute the training stage. As shown in FIG. 5, the method is executed by the AI cloud apparatus 20 and comprises the steps of:

fetching at least one image information sent from the edge computing apparatus 10 (S51), wherein the image information comprises at least one defective information;

generating at least one label information according to the image information (S52);

creating a training model according to the label information (S53); and

updating the training model and allowing the edge computing apparatus 10 to download the updated training model (S54).

The image information may be in a plural number. The label information may be in a plural number. However, the present disclosure is not limited thereto. In this preferred embodiment, the step of generating at least one label information according to the image information (S52) is carried out by executing a label tool program on the cloud computing server 22 of the AI cloud apparatus 20 and using the label tool program to label image information which has defective information so as to generate the label information. The label information comprises an object inspection category information and/or a semantic segmentation category information.

In this preferred embodiment, the step of creating a training model according to the label information (S53) is carried out by executing at least one scheduled training program and a performance management tool program on the cloud computing server 22 of the AI cloud apparatus 20. The scheduled training program has built-in models which are conducive to scheduled training, so as to create the training model. The performance management tool program records at least one performance index for use in training and inference. The performance index comprises a time information and a resource consumption information. The resource consumption information comprises CPU/RAM resource consumption information and GPU Core/GPU RAM resource consumption information.

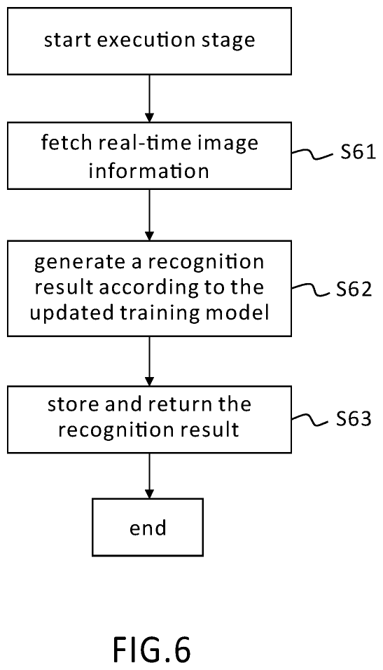

In this preferred embodiment, upon the completion of the training stage and the creation of an updated training model by the edge computing apparatus 10 according to the training model, the method further comprises a step, i.e., the edge computing apparatus 10 starts an execution stage. As shown in FIG. 6, the method is executed by the edge computing apparatus 10 and comprises the steps of:

fetching a real-time image information by performing an automatic optical inspection (AOI) process (S61);

generating a recognition result according to the real-time image information and the updated training model (S62); and

storing and returning the recognition result to the AI cloud apparatus 20 (S63).

In this preferred embodiment, the recognition result comprises a defective recognition result. The training stage is restarted in real time through AI technology, whereas the training model is created and updated in real time through the label information, so as to enhance visual inspection efficiency.

While the present disclosure has been described by means of specific embodiments, numerous modifications and variations could be made thereto by those skilled in the art without departing from the scope and spirit of the present disclosure set forth in the claims.

What is claimed is:

1. An AI process flow management method for automatic visual inspection, with an AI cloud apparatus connected to a network and adapted to execute a training stage and thus execute the method, the method comprising the steps of:
fetching at least one image information;
generating at least one label information according to the image information;
creating a training model according to the label information; and
updating the training model and allowing the updated training model to be downloaded.

2. The AI process flow management method for automatic visual inspection according to claim 1, further, according to execution of the step of generating at least one label information according to the image information, comprising the steps of:
executing a label tool program; and
labeling the image information through the label tool program so as to generate the label information.

3. The AI process flow management method for automatic visual inspection according to claim 1, wherein the label information comprises an object inspection category information and/or a semantic segmentation category information.

4. The AI process flow management method for automatic visual inspection according to claim 1, further, in addition to the step of creating a training model according to the label information, comprising the steps of:
executing at least one scheduled training program; and
creating the first training mode by performing scheduled training with built-in models of the scheduled training program.

5. The AI process flow management method for automatic visual inspection according to claim 4, further, in addition to the step of creating a training model according to the label information, comprising the steps of:
executing a performance management tool program; and
recording at least one performance index for use in training and inference, wherein the performance index comprises a time information and a resource consumption information.

6. The AI process flow management method for automatic visual inspection according to claim 5, wherein the scheduled training program and the performance management tool program are executed on a visualized graphic interface.

7. The AI process flow management method for automatic visual inspection according to claim 1, further comprising the step of starting an execution stage by the edge computing apparatus, wherein the edge computing apparatus executes the steps of:
fetching a real-time image information;
generating a recognition result according to the training model; and
storing and returning the recognition result.

8. The AI process flow management method for automatic visual inspection according to claim 7, wherein, before the edge computing apparatus starts the execution stage, the AI cloud apparatus downloads the training model.

9. The AI process flow management method for automatic visual inspection according to claim 7, further comprising the step of performing an automatic optical inspection process to fetch the real-time image information.

10. The AI process flow management method for automatic visual inspection according to claim 7, further comprising the step of generating the recognition result according to the real-time image information and the training model.

11. An AI process flow management system for an automatic visual inspection, comprising:
an edge computing apparatus connected to a network; and
an AI cloud apparatus for exchanging data with the edge computing apparatus through the network,
wherein, in order for the AI cloud apparatus to be executed in a training stage, the AI cloud apparatus fetches at least one image information, generates at least one label information according to the image information, creates a training model according to the label information, updates the training model, and allows the edge computing apparatus to download the updated training model, thereby allowing the edge computing apparatus to start an execution stage.

12. The AI process flow management system for automatic visual inspection according to claim 11, wherein the AI cloud apparatus comprises an AI training server and a cloud computing server, the cloud computing server being connected to the edge computing apparatus and the AI training server, the AI training server being connected to the edge computing apparatus, wherein the cloud computing server fetches the image information through the AI training server and provides the label information to the AI training server for training in order to create the training model, and the cloud computing server updates the training model.

13. The AI process flow management system for automatic visual inspection according to claim 11, further comprising edge computing apparatuses connected to the AI cloud apparatus through a network, wherein the image informations fetched by the edge computing apparatuses are sent to the AI cloud apparatus.

14. The AI process flow management system for automatic visual inspection according to claim 11, further comprising edge computing apparatuses and a storing device, wherein the edge computing apparatuses are connected to the AI cloud apparatus through a network, and the image information fetched by the edge computing apparatuses are sent to the AI cloud apparatus, wherein the storing device is disposed between the AI cloud apparatus and the edge computing apparatuses, and the image informations fetched by the edge computing apparatuses are collected and compiled.

15. The AI process flow management system for automatic visual inspection according to claim 11, wherein the edge computing apparatus comprises an inspection device and an inference device connected to the inspection device, and the inspection device sends the image information to the AI cloud apparatus, wherein the inference device and the AI cloud apparatus are connected.

16. The AI process flow management system for automatic visual inspection according to claim 11, wherein the edge computing apparatus comprises inspection devices and an inference device connected to the inspection devices, and the inspection devices send the image information to the AI cloud apparatus, wherein the inference device downloads the training model from the AI cloud apparatus.

17. The AI process flow management system for automatic visual inspection according to claim 14, wherein the storing device is a server.

18. The AI process flow management system for automatic visual inspection according to claim 15, wherein the inspection device is an automatic optical inspection computer device.

19. The AI process flow management system for automatic visual inspection according to claim 18, wherein the inference device is a graphics processing unit, and the inference device is disposed in the inspection device.

20. The AI process flow management system for automatic visual inspection according to claim 18, wherein the inference device is a GPU inference computer device, and the inference device is connected to the inspection device by proximal wired connection.

21. The AI process flow management system for automatic visual inspection according to claim 11, further comprising an electronic device connected to a network and adapted to log in the AI cloud apparatus.

22. The AI process flow management system for automatic visual inspection according to claim 11, wherein, in order to start the execution stage, the edge computing apparatus fetches a real-time image information, and the updated training model generates a recognition result according to the real-time image information, stores the recognition result and returns the recognition result to the AI cloud apparatus.
